(19) United States
(12) Patent Application Publication
(10) Pub. No.: US 2003/0146904 A1
(43) Pub. Date: Aug. 7, 2003

(54) Keyboard assembly

(76) Inventor: Kuo Shu Cheng, Hsin-Tien City (TW)

Correspondence Address: BROWDY AND NEIMARK, P.L.L.C., 624 NINTH STREET, NW, SUITE 300, WASHINGTON, DC, 20001-5303, US

(21) Appl. No.: 10/213,380

(22) Filed: Aug. 7, 2002

(30) Foreign Application Priority Data
Feb. 5, 2002 (TW) 91201350

(51) Int. Cl. G09G 5/00

(52) U.S. Cl. 345/168

(57) ABSTRACT

A keyboard assembly comprises a typing section, a function key section at top side of the typing section, cursor and screen-control section at right side of the typing section and a number/editing section at right side of the typing section. Therefore, user can use right hand for operating mouse while using left hand for operating the number/editing section, thus saving labor of right hand and enhancing operation efficiency.

### FIELD OF THE INVENTION

The present invention relates to a keyboard assembly, especially to a keyboard assembly for computer.

### BACKGROUND OF THE INVENTION

Keyboards are basic input devices for computer and the most common key layout of a keyboard is shown in FIG. 4. The area on the keyboard is divided into four sections, i.e., a typing section 11a, a function key section 12a, a cursor and screen-control section 13a and a number/editing section (numeric keypad) 14a. The typing section 11a has a plurality of number keys on top row thereof. Moreover, additional number keys and editing keys are provided on the number/editing section 14a to facilitate the number inputting and text editing function for right-handed user. The keyboard with above-mentioned layout is particularly useful in DOS environment.

However, for operation system with graphic user interface such as mouse, this layout is not convenient for user with extensive input task and using mouse with right hand such as drafts man and bank staff. For those workers, their right hands are extensively used and industrial disease is liable to occur.

### SUMMARY OF THE INVENTION

It is an object of the present invention to provide a keyboard assembly for computer by which user can use right hand for mouse and left hand for operating the number/editing region, whereby operation efficiency can be enhanced and the load on right hand can be relieved.

To achieve above-mentioned object, the present invention provides a keyboard assembly comprising a typing section, a function key section at top side of the typing section, a cursor and screen-control section at right side of the typing region and a number/editing section at right side of the typing region. Therefore, user can use right hand for operating mouse while using left hand for operating the number/editing section.

The various objects and advantages of the present invention will be more readily understood from the following detailed description when read in conjunction with the appended drawing, in which:

### BRIEF DESCRIPTION OF DRAWINGS

FIG. 1 shows the top view of a conventional keyboard;

FIG. 2 shows the top view of the first preferred embodiment of the present invention;

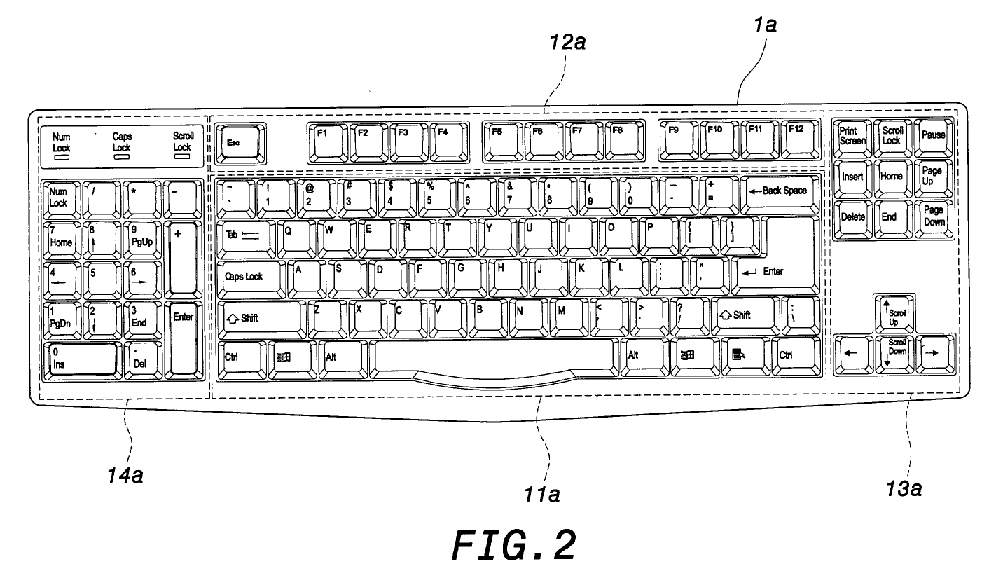

FIG. 3 shows the top view of the second preferred embodiment of the present invention.

### DESCRIPTION OF THE INVENTION

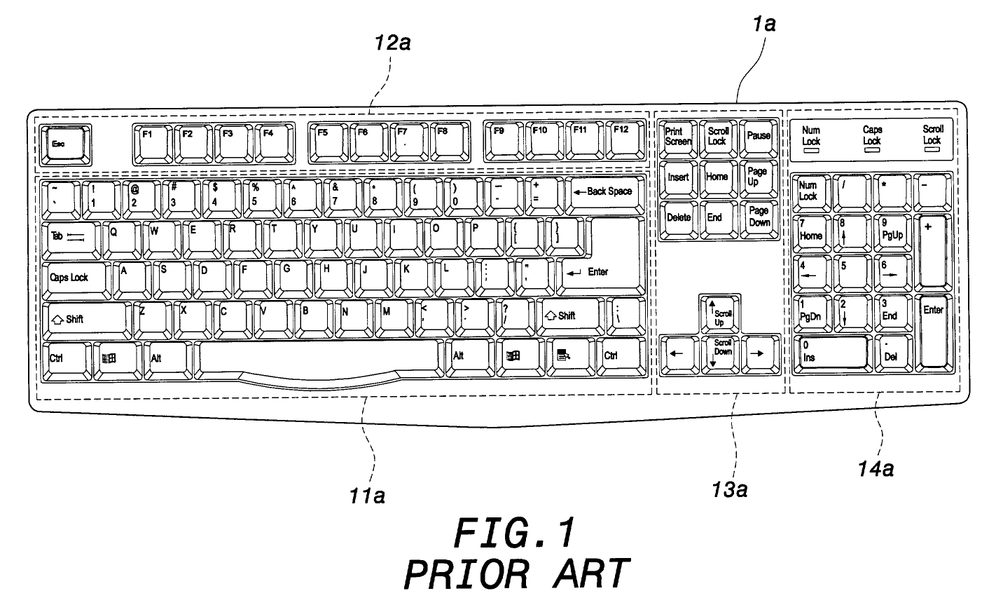

FIG. 1 shows the first preferred embodiment of the present invention. The keyboard according to the present invention has a typing section 11, a function key section 12, a cursor and screen-control section 13 and a number/editing section 14.

The typing section 11 is used for text or command input and occupies largest area on the keyboard. The typing section 11 comprises keys such as number keys 0-9, alphabet keys a-z, arithmetic keys +, −, *, /, special symbols !, @, #, $., control keys Caps Lock, Ctrl key, space key and Enter key, etc.

The function key section 12 is located at atop the typing section 11 and comprises hot keys F1-F12 for simplifying operation and an Esc key.

The cursor and screen-control section 13 is located at right side of the typing region 11 and used for move a cursor on screen. The cursor and screen-control section 13 comprises keys such as four cursor-control keys, Insert, Delete, Home, End, Page Up and Page Down.

The number/editing section (numeric keypad) 14 is moved to left side of the typing section 11 and comprises number keys and editing keys. When the Num Lock key is pressed, an Num Lock indicator light is turned on and the number/editing section 14 is used for inputting number and period. When the Num Lock key is pressed again, the Num Lock indicator light is turned off and the number/editing section 14 is used for editing function.

Moreover, the Num Lock indicator light, the Caps Lock indicator light and Scroll Lock indicator light are also moved to left side of the keyboard 1.

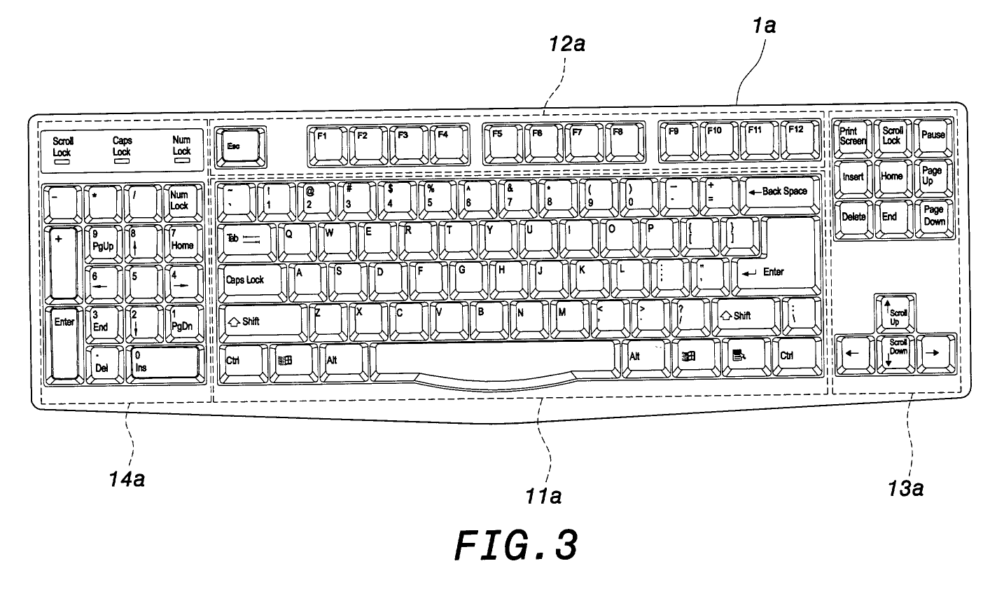

FIG. 3 shows the second embodiment of the present invention, the sections 11-14 have the same location as in the first embodiment except that the keys on the number/editing section 14 are reverted along a central vertical line.

As can be seen from above description, the keyboard of the present invention can solve the conventional problem of heavy burden on right hand, wherein the number/editing section is moved to left side of the typing section. The keyboard of the present invention can reduce burden of right hand and enhance operation efficiency. Moreover, the keyboard of the present invention is also suitable for southpaw user.

It should be noted that the internal circuit and contact layout of the keyboard 1 also need modification if the number/editing section 14 is moved to left side of the typing section 11.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A keyboard assembly connected to a computer for inputting command and data and comprising a typing section, a function key section, a cursor and screen-control section and a number/editing section, wherein the number/editing section is placed at a left side of the typing section.

2. The keyboard assembly as in claim 1, wherein those sections have key layout same as standard keyboard.

3. The keyboard assembly as in claim 1, wherein the typing section, the function key section, and the cursor and screen-control section have key layout same as standard keyboard and the number/editing section has keys being reverted along a central vertical line as compared with standard keyboard.
